(19) United States
(12) Patent Application Publication
(10) Pub. No.: US 2004/0061441 A1
(43) Pub. Date: Apr. 1, 2004

(54) System and method for supporting arc tubes in HID lamps

(76) Inventors: Jeffrey L. Johanning, Hudson, OH (US); Jiri G. Sip, Strongsville, OH (US); Joshua D. Barry, Twinsburg, OH (US)

Correspondence Address: Duane Morris LLP, Suite 700, 1667 K. Street N.W., Washington, DC, 20006, US

(21) Appl. No.: 10/628,396

(22) Filed: Jul. 29, 2003

Related U.S. Application Data
(63) Continuation-in-part of application No. 09/534,443, filed on Mar. 24, 2000.

(51) Int. Cl. H01J 11/00

(52) U.S. Cl. 313/567

(57) ABSTRACT

A system and method for mechanically supporting and electrically coupling arc tubes in high intensity discharge (“HID”) lamps such as metal halide lamps. The system and method provides mechanical support and electrical coupling of the arc tube in HID lamps with few or no welds and is particularly suited for HID lamps having relatively large arc tubes, e.g. lamps having wattages greater than about 150 watts or other wattage lamps having a heat reflector mounted near the base of the lamp.

### CROSS REFERENCE TO OTHER PATENT APPLICATIONS

This application is a continuation-in-part of pending U.S. patent application Ser. No. 09/534,443 filed Mar. 24, 2000, entitled “System and Method of Supporting Arc Tubes in HID Lamps” and assigned to the Assignee of the present invention, the content of which is incorporated herein by reference.

### BACKGROUND OF THE INVENTION

The present invention relates to systems and methods for mechanically supporting and electrically coupling arc tubes in high intensity discharge (“HID”) lamps such as metal halide lamps. More particularly, the invention relates to such systems and methods which provide mechanical support and electrical coupling of the arc tube in HID lamps with few or no welds.

HID lamps such as metal halide lamps have found widespread acceptance in lighting large outdoor and indoor areas such as athletic stadiums, gymnasiums, warehouses, parking facilities, and the like, because of the relatively high efficiency, compact size, and low maintenance of HID lamps when compared to other lamp types. A typical HID lamp includes an arc tube which is mechanically supported within a light-transmissive outer lamp envelope. The arc tube includes two or more electrical leads which are each electrically coupled to a source of electrical power exterior of the outer lamp envelope.

In such a lamp, the mounting structure which provides mechanical support and electrical coupling for the arc tube within the outer lamp envelope includes one or more metal components which are welded for mechanical and electrical integrity. In the fabrication of such lamps, the practice of welding such components, unless automated, is labor intensive adding expense to the fabrication process. Further, the welding of various lamp components requires numerous weld schedules for the components which may comprise different materials and geometries. Still further, welding electrodes require a significant amount of maintenance to achieve an optimum weld. Thus the elimination of welds in the mounting structure for the arc tube is desirable to reduce the time and expense required to fabricate such lamps.

Another disadvantage of the typical HID lamp mounting structure having welds to maintain the mechanical and electrical integrity of the structure results from the susceptibility of the one or more welds in such lamps to mechanical failure during shipping of the lamps. The welds provide a relatively strong mechanical coupling of components when the weld is subjected to shear. However, the welds are relatively weak when subjected to a bending moment, which is the typical mode of mechanical failure in such lamps during shipping. Mechanical failure of the arc tube mounting structure is of particular concern in high wattage lamps because of the relative size and weight of the arc tubes, and the shape of the arc tubes used in such lamps.

Many relatively large lamps include a heat reflector mounted within the outer envelope of the lamp between the arc tube and the base of the lamp. The heat reflector protects the base of the lamp from excessive heat by reflecting heat radiated from the arc tube away from the base. In lamps having a vertical orientation, a convective flow of gases may develop within the lamp envelope during operation of the lamp further contributing to the heating of the lamp base. The heat reflector further protects the lamp base by obstructing the convective flow of hot gas. The known reflectors are typically formed by welding several components together, and then welding the reflector to the mounting frame. The multiple component construction of the reflectors and the attachment of the reflector to the mounting structure by welding adds material and labor costs to the fabrication process.

Another drawback in the design of prior art lamps having reflectors results for the necessity to provide an insulated path through the reflector nearest the lamp base for the passage of current conductors between the lamp base and the arc tube. Typically, each current conductor is insulated by a section of quartz tubing. However the process of insulating each conductor with the tubing adds material and labor costs to the fabrication process.

Yet another drawback in the fabrication of high wattage lamp results from the necessity to provide lateral support for the mounting structure near the end of the outer lamp envelope opposite the lamp base. In the typical physically large lamp, a pair of metal strips is welded to the frame of the mounting structure near the closed end of the outer lamp envelope so that the end portions of each strip extend laterally from the frame. The strips are dimensioned to serve as a spacer between the mounting structure and the outer lamp envelope wall to reduce lateral movement of the mounting structure within the envelope.

Accordingly, it is an object of the present invention to provide a novel system and method for mechanically supporting and electrically coupling arc tubes in HID lamps which obviates the deficiencies of known systems and methods.

It is another object of the present invention to provide a novel system and method for mechanically supporting and electrically coupling arc tubes in HID lamps with few or no components which are welded for mechanical integrity.

It is yet another object of the present invention to provide a novel system and method for mechanically supporting and electrically coupling arc tubes in HID lamps with few or no components which are welded for electrical integrity.

It is still another object of the present invention to provide a novel system and method for mechanically supporting and electrically coupling arc tubes in HID lamps which is amenable to automation.

It is a further object of the present invention to provide a novel system and method for mechanically supporting and electrically coupling arc tubes in HID lamps which reduces mechanical failure during shipping of the lamp.

It is yet another object of the present invention to provide a novel heat reflector for high wattage lamps and a novel system and method for mechanically supporting heat reflectors in such lamps.

It is still a further object of the present invention to provide a novel electric insulator and a novel system and method for electrically insulating the leads within the outer envelope of HID lamps.

These and many other objects and advantages of the present invention will be readily apparent to one skilled in the art to which the invention pertains from a perusal of the claims, the appended drawings, and the following detailed description of the preferred embodiments.

### BRIEF DESCRIPTION OF THE DRAWINGS

FIG. 1 is a schematic illustrating a mounting structure for a high wattage lamp according to one aspect of the present invention.

FIG. 2a is a schematic illustrating an arc tube holder according to one aspect of the present invention.

FIG. 2b is a schematic illustrating an arc tube holder according to another aspect of the present invention.

FIG. 3 is a schematic illustrating a heat reflector according to one aspect of the present invention.

FIG. 4 is a schematic illustrating a mounting structure for a high wattage lamp according to one aspect of the present invention.

FIG. 5 is a schematic illustrating an insulator according to one aspect of the present invention.

### DESCRIPTION OF PREFERRED EMBODIMENTS

While the present invention is suitable for mechanically supporting and electrically coupling arc tubes in any type of HID lamp, it may be easily understood in the embodiment suitable for relatively large metal halide lamps.

Metal halide lamps include light emitting chemicals which are hermetically sealed within an arc tube formed from light transmitting material such as quartz glass or ceramics. The arc tube must be mechanically supported and electrically coupled within the outer lamp envelope and there are many known configurations for the arc tube mounting structure. There are many sizes of metal halide lamps which range between about 32 watts and 2000 watts and generally include either a medium type base for lower wattage lamps (150W or below) or a mogul type base for higher wattage lamps (175W or greater).

Lamps with Large Arc Tubes:

An embodiment of the present invention is suitable for HID lamps having relatively large arc tube. These lamps typically include high wattage lamps (i.e. lamps of greater than 150 watts), but may also include other wattage lamps that include a heat reflector mounted near the base of the lamp. The welds used to maintain the mechanical integrity of the arc tube mounts in these lamps are particularly susceptible to failure due to the relative size of the arc tubes in such lamps compared to the arc tubes in other lamps. Relatively large lamps typically include a heat reflector mounted between the arc tube and the lamp base to protect the lamp base from excessive heat due to radiation from the arc tube and convection. These large lamps also typically include a spacer mounted near the closed end of the outer envelope to reduce lateral movement of the mounting structure within the envelope.

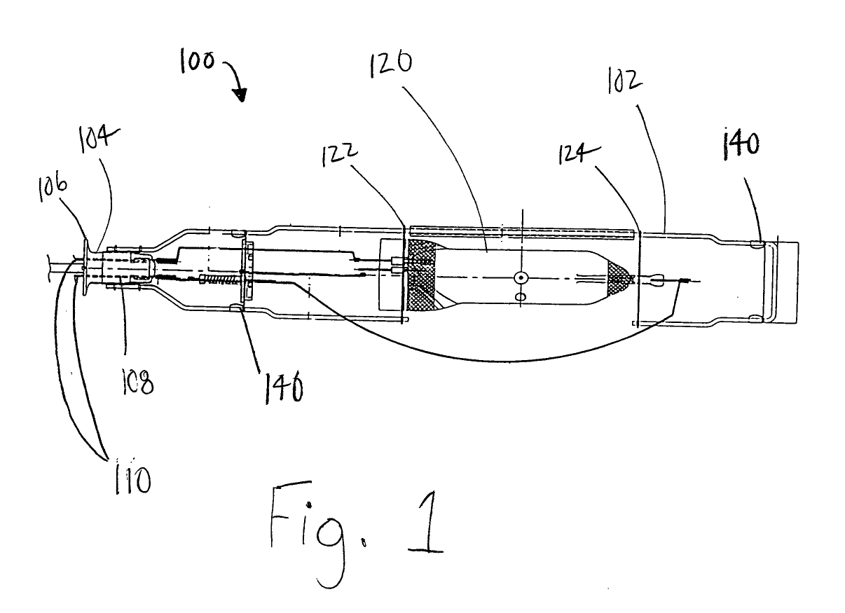

FIG. 1 illustrates one embodiment of a mounting structure according to the present invention for mechanically supporting and electrically coupling the arc tube in an HID lamp. With reference to FIG. 1, the mounting structure 100 includes a frame 102 which is mechanically connected at one end to a lamp stem assembly 104. The stem assembly 104 comprises a stem 106, a stem clip 108, and two stem leads 110 which provide an electrical coupling between the arc tube 120 supported within the outer lamp envelope (not shown) to a source of electrical power (not shown) for operating the lamp.

The arc tube 120 is mechanically supported at each end by an arc tube holder 122,124. In one embodiment of the present invention, the integrity of the mechanical support of the arc tube holders 122,124 from the frame 102 is maintained without welds.

A heat reflector 140 is supported from the frame 102 between the arc tube 120 and the lamp stem assembly 104. A spacer 141 is supported from the frame 102 near the other end of the frame. In one embodiment of the present invention, the integrity of the mechanical support of the heat reflector and/or the spacer 141 from the frame 102 is maintained without welds. In another embodiment of the present invention, the spacer 141 may comprise an element identical to the heat reflector 140 thus reducing the number of different components required in the fabrication of the mounting structure.

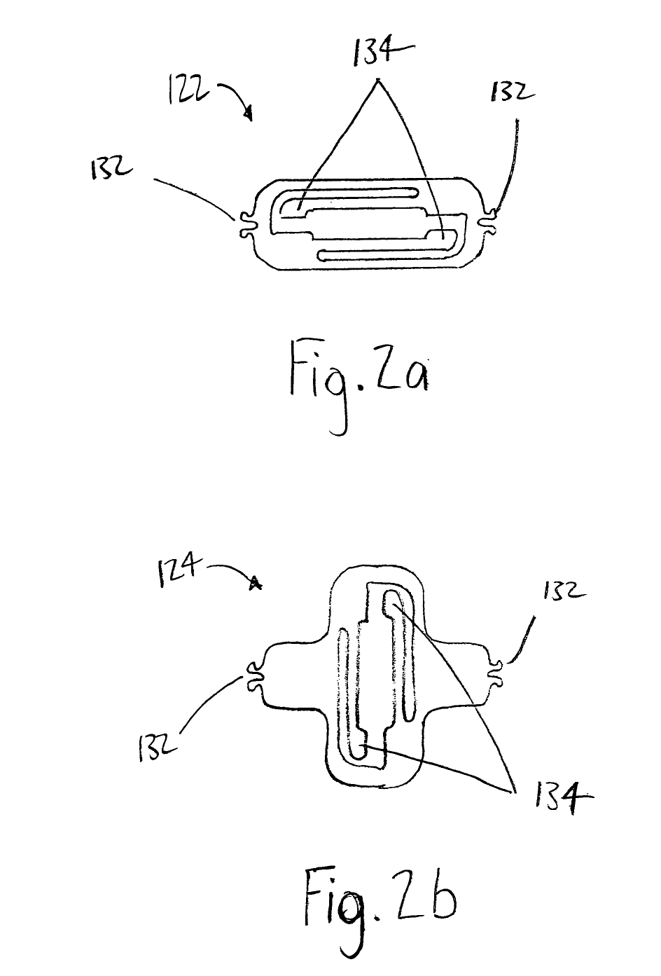

FIGS. 2a and 2b illustrate the arc tube clips 122,124 of one embodiment of the present invention. With reference to FIGS. 2a and 2b, each arc tube holder 122,124 is a thin one-piece metallic element having laterally opposing pairs of frame receiving tabs 132, and a pair of spaced apart cantilevered portions 134. The cantilevered portions 134 are spaced apart a distance sufficient to receive and retain the pinched end of an arc tube 120 therebetween.

Each pair of tabs 132 projects peripherally from the element and may be deformed around a portion of the frame 102 to thereby mechanically support the arc tube holder 122,124 from the frame.

In the embodiment of the arc tube holder 124 illustrated in FIG. 2b, the cantilevered portions 143 extend substantially perpendicular to the axis formed by the frame retaining tabs 132 so that the pinched portion of the arc tube retained therebetween may be offset 90 degrees from the plane of the frame 102.

As illustrated in FIG. 2a, the cantilevered portions 134 extend substantially parallel to the axis formed by the frame retaining tabs 132. The combination of the arc tube holders 122,124 having offset cantilevered portions 134 enables an arc tube having offset pinches to be mechanically supported from the frame.

The cantilevered portions 134 may be sufficiently resilient so that the free ends thereof will deflect when subjected to mechanical force. The resiliency of the cantilevered portions 134 thereby provides limited axial movement of the arc tube 120 supported by the arc tube holders 122,124. The limited axial movement of the arc tube thereby reduces the mechanical failure of the mounting structure when subjected to mechanical agitation.

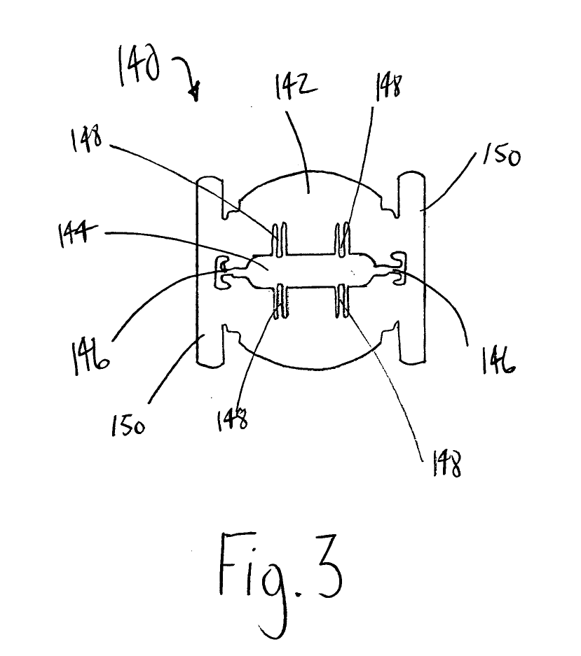

FIG. 3 illustrates the heat reflector of one embodiment of the present invention. With reference to FIG. 3, the heat reflector 140 is a thin one-piece metallic disc having a substantially planar heat reflecting surface 142 with an elongated slot 144 formed therein. The heat reflector includes laterally opposing pairs of frame retaining tabs 146 and two pair of opposing insulator retaining tabs 148.

The frame retaining tabs 146 may be mechanically deformed around a portion of the frame 102 to thereby mechanically support the heat reflector 140 from the frame. Each of the elongated tabs 150 may be bent approximately 90 degrees from the plane of the surface 142 to enhance the integrity of mechanical support of the reflector 140 from the frame 102.

As discussed earlier, the spacer 141 mounted near the other end of the frame 102 may comprise an identical thin one-piece metallic disc.

Electrical Coupling:

In addition to providing mechanical support for the arc tube in HID lamps, the mounting structure provides electrical coupling of the arc tube to a source of electrical power for operating the lamp. The aspect of the present invention directed to the electrical coupling of the arc tube to a power source is suitable for any type HID lamp and may be easily understood in the embodiment for HID lamps having a heat reflector to protect the lamp base from excessive heat.

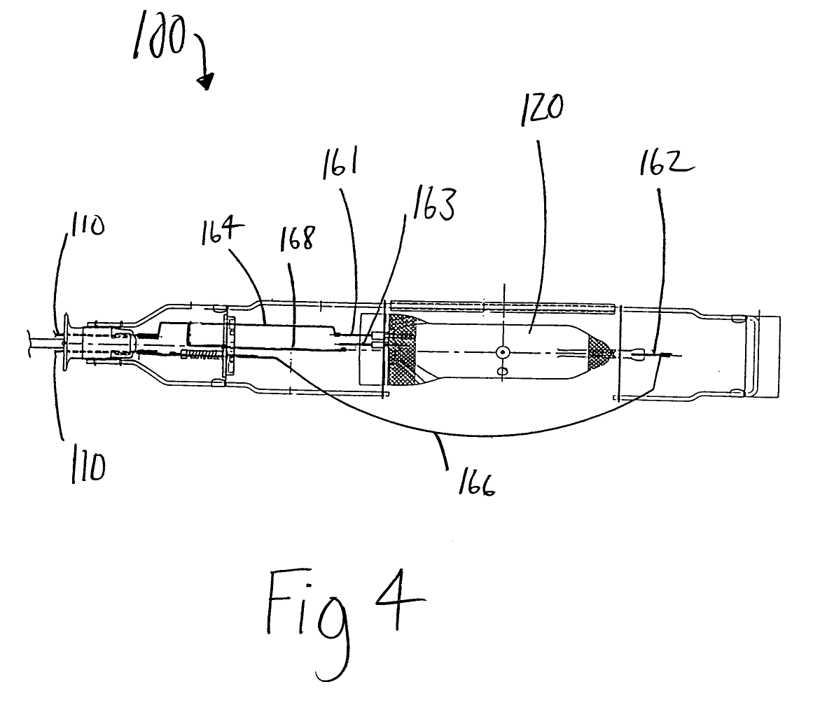

FIG. 4 illustrates the embodiment of the present invention illustrated in FIG. 1. With reference to FIG. 4, the mounting structure 100 includes the stem leads 110 that each provide electrical coupling between the arc tube 120 and a source of electrical power (not shown).

The arc tube 120 includes the arc tube lead 161 at one end, the arc tube lead 162 at the other end, and the starting electrode lead 163 at one end thereof. The connector 164 provides electrical coupling between the arc tube lead 161 and one of the stem leads 110. The connector 166 provides electrical coupling between the arc tube lead 162 and the other stem lead 110. The connector 168 provides electrical coupling between the starting electrode lead 163 and one of the stem leads 110. In one embodiment of the present invention, the integrity of the electrical coupling between the arc tube leads 161,162 and the stem leads 110, and/or the starting electrode lead 163 and one of the stem leads 110, may be maintained without welds.

As illustrated in FIG. 4, the connectors 164,166,168 must pass through the heat reflector 140 to in order to connect the stem leads 110 with the respective arc tube leads 161,162 or starting electrode lead 163. In a typical high wattage lamp, the heat reflector 140 is formed from an electrically conductive material. In the embodiment illustrated in FIG. 4, the heat reflector 140 is metallic. Thus it is necessary to electrically insulated the connectors 164,166,168 from the heat reflector 140.

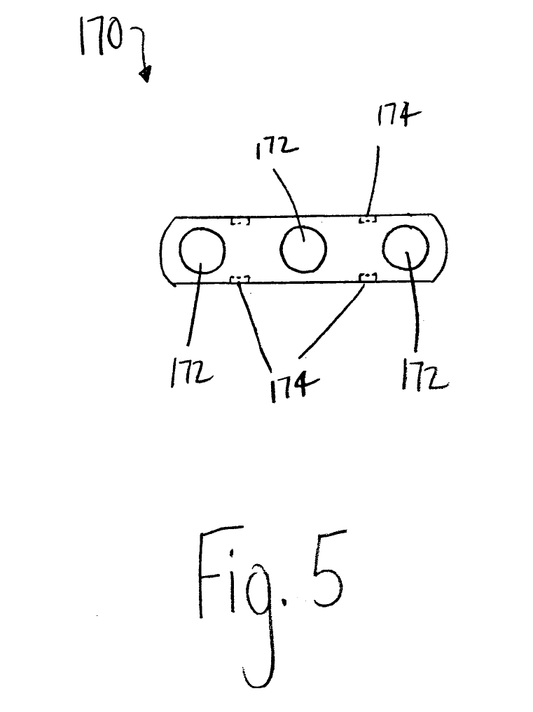

FIG. 5 illustrates one embodiment of an insulator according to the present invention. With reference to FIG. 5, the insulator 170 is a monolithic element forming plural apertures 172. The insulator 170 may be formed from any suitable non-electrically insulative material such as ceramic. The insulator 170 is dimensioned so that it may be disposed and retained within the slot 144 formed in the heat reflector 140. To enhance the integrity of the mechanical support of the insulator 170 from the reflector 140, the grooves 174 may be formed in the sides of the insulator 170 to engage the tabs 148 when the insulator 170 is disposed within the slot 144.

The apertures 172 are each dimensioned so that the one of the connectors 164,166 may pass therethrough. Thus each aperture 172 provides an electrically insulative passage through the heat reflector 140.

While preferred embodiments of the present invention have been described, it is to be understood that the embodiments described are illustrative only and the scope of the invention is to be defined solely by the appended claims when accorded a full range of equivalence, many variations and modifications naturally occurring to those of skill in the art from a perusal hereof.

What is claimed is:

1. An HID lamp comprising:
a. an outer lamp envelope having an opening at one end;
b. an arc tube mounted within said outer lamp envelope, said arc tube having at least on arc tube lead at each end thereof; and
c. a mounting structure for supporting said arc tube within said outer lamp envelope and for providing electrical coupling between the arc tube and an electrical power receiving lamp base, said mounting structure comprising:
i. a stem assembly mounted at the open end of said lamp envelope, said stem assembly including a stem and first and second stem leads each providing an electrical connection from the interior of the lamp envelope to the exterior of the lamp envelope;
ii. an elongated frame weldlessly supported at one end by said stem assembly;
iii. a pair of spaced apart reflectors weldlessly supported by said frame, one of said reflectors being supported adjacent said lamp stem, the other of said reflectors being supported adjacent the distal end of said frame;
iv. a pair of spaced apart arc tube holders weldlessly supported by said frame between said pair of reflectors, one of said arc tube holders supporting the end of the arc tube nearer the stem assembly, the other of said arc tube holders supporting the other end of the arc tube;
v. a first electrical connector electrically coupling the first stem lead to one of said arc tube leads; and
vi. a second electrical connector electrically coupling the second stem lead to the other of said arc tube leads.

2. The HID lamp of claim 1 wherein the electrical coupling between the arc tube leads and the stem leads includes no welds.

3. The HID lamp of claim 1 further comprising an insulator supported from the reflector adjacent said lamp base, said insulator being formed from electrically insulative material and forming one or more apertures suitable for receiving one of said electrical connectors therethrough, said insulator providing electrical insulation between said electrical connector and the reflector.

4. The HID lamp of claim 3 wherein the insulator is formed from ceramic material.

5. The HID lamp of claim 4 wherein the insulator forms three apertures.

6. The HID lamp of claim 1 wherein at least one of said lamp holders comprises a thin element having laterally opposing pairs of peripheral projections, each pair of projections being mechanically deformed around a portion of said elongated frame to thereby secure the arc tube holder to the frame, and a pair of spaced apart, laterally opposing, cantilevered portions, the space between said portions being dimensioned to receive and retain a pinched end of said arc tube.

7. The HID lamp of claim 6 wherein the axis formed by said laterally opposing pairs of peripheral projections is substantially parallel to said cantilevered portions.

8. The HID lamp of claim 6 wherein the axis formed by said laterally opposing pairs of frame peripheral projections is substantially perpendicular to said cantilevered portions.

9. The HID lamp of claim 1 wherein said reflector adjacent said lamp stem comprises a disc having a planer reflecting surface with an elongated slot therein intermediate a pair of frame retaining tabs for attachment to spaced apart elements of the frame.

10. The HID lamp of claim 9 further comprising a plural aperture monolithic ceramic insulator disposed within said elongated slot to thereby define separate plural passageways for electrical conductors through said disc.

11. The HID lamp of claim 9 wherein said reflectors are substantially identical.

12. The HID lamp of claim 1 wherein said arc tube is axially moveable within a limited range within said outer lamp envelope.

13. In a high intensity discharge lamp including an outer lamp envelope, a disc shaped reflector supported within the outer lamp envelope near the base of the lamp, and an arc tube supported within the outer envelope, the improvement comprising a second disc shaped reflector mounted near the closed end of the envelope.

14. In a high intensity discharge lamp including an outer lamp envelope, an arc tube, and a mounting structure for laterally and axially supporting the arc tube within the outer lamp envelope, the improvement wherein the mounting structure provides for limited axial movement of the arc tube to thereby reduce mechanical failure of the mounting structure when subjected to mechanical agitation.

15. In a high intensity discharge lamp including an envelope enclosing a lamp stem assembly mounted at the opening at one end of the envelope, a lead providing an electrical path between the stem assembly and an arc tube through a reflector, and means for electrically insulating the lead from the reflector, the improvement wherein said insulating means is an apertured ceramic supported by said reflector.

16. The lamp of claim 15 including a second lead providing an electrical path between said stem assembly and the arc tube through the reflector, and means for electrically insulating said second lead from said reflector; and
wherein said apertured ceramic is a monolithic structure having at least two spaced apart apertures, one of said leads passing through one of said apertures and the other of said leads passing through the other of said apertures.

17. A structure for mounting a high wattage arc tube within the outer lamp envelope of an HID lamp, said mounting structure comprising an elongated frame supporting a pair of spaced apart arc tube holders along the length thereof, each of said arc tube holders being adapted to support one end of a high wattage arc tube, wherein there being no weld between each of said arc tube holders and said frame.

18. The mounting structure of claim 17 further comprising a pair of spaced apart reflectors supported by said frame along the length thereof, wherein there being no weld between each of said reflectors and said frame.

19. A structure for mounting an arc tube within the outer lamp envelope of an HID lamp, said mounting structure comprising:
a rigid frame comprising substantially parallel spaced apart elongated legs;
a pair of spaced apart arc tube holders supported by said frame along the length thereof, at least one of said arc tube holders comprising an arc tube retaining portion disposed between a pair of frame retaining tabs, one of said frame retaining tabs receiving a portion of one of said substantially parallel legs therein, the other of said frame retaining tabs receiving a portion of the other of said substantially parallel legs therein, the arc tube retaining portion receiving a portion of one end of a high wattage arc tube therein.

20. The mounting structure of claim 19 wherein the arc tube retaining portion of at least one of said arc tube holders comprises a pair of spaced apart, laterally opposing cantilevered portions being dimensioned to receive and retain a pinched end of an arc tube.

21. A structure for mounting an arc tube within the outer lamp envelope of an HID lamp, said mounting structure comprising an elongated frame, a pair of spaced apart reflectors supported by said frame along the length thereof, and an arc tube supported by said frame between said pair of reflectors, wherein there being no weld between each of said reflectors and said frame.

22. A structure for mounting an arc tube within the outer lamp envelope of an HID lamp, said mounting structure comprising:
a rigid frame comprising substantially parallel spaced apart elongated legs;
a pair of spaced apart reflectors supported by said frame along the length thereof, at least one of said reflectors comprising a pair of spaced apart frame retaining tabs, one of said frame retaining tabs receiving a portion of one of said substantially parallel legs therein, the other of said frame retaining tabs receiving a portion of the other of said substantially parallel legs therein.

23. The mounting structure of claim 22 wherein at least one of said reflectors comprises a portion intermediate said frame retaining tabs forming an aperture.

24. The mounting structure of claim 23 further comprising an insulator received within said aperture formed by one of said reflectors, said insulator comprising electrically insulative material forming one or more wire guiding apertures, each of said wire guiding apertures being adapted to receive an electrically conductive wire therethrough to thereby electrically insulate said wire from said reflector.

25. A mounting structure for supporting an arc tube in the outer lamp envelope of an HID lamp, said mounting structure comprising:
a lamp stem assembly;
a rigid frame supported by said lamp stem assembly, said frame comprising elongated spaced apart elements;
a pair of arc tube holders supported by said frame along the length thereof, each of said arc tube holders comprising a thin one-piece metallic element having laterally opposing pairs of peripheral projections, each pair of projections being mechanically deformed around one of said spaced apart frame elements to thereby secure the arc tube holder to the frame, and a pair of spaced apart, laterally opposing, cantilevered portions, the space between said portions being dimensioned to receive and retain a pinched end of an arc tube;
a pair of reflectors supported by said frame along the length thereof, at least one of said reflectors comprising a thin one-piece metallic disc having a substantially planar reflecting surface with an elongated slot therein and spaced apart laterally opposing pairs of frame retaining elements, each pair of frame retaining elements being mechanically deformed around one of said spaced apart frame elements to thereby secure the reflector to the frame; and
a plural aperture monolithic ceramic insulator disposed within said elongated slot to thereby define separate plural passageways for electrical conductors through said disc.

26. A reflector adapted to be carried by spaced apart elements of the frame of an HID lamp comprising:
a disc having a substantially planer reflecting surface with an elongated slot therein; and
a plural aperture monolithic ceramic insulator disposed within said slot to thereby define separate plural passageways for electrical conductors through said disc.

27. The reflector of claim 26 wherein said surface includes plural deflectable portions integral therewith for maintaining said insulator within said slot.

28. The reflector of claim 26 wherein said disc includes opposing lateral portions selectively deformable out of the plane of said surface to thereby cooperate with portions of said disc in the plane of said surface to mechanically secure the reflector to the frame when carried thereby.

29. The reflector of claim 28 wherein said opposing lateral portions are generally normal to the length of said slot.

30. An arc tube holder for an HID lamp having a frame with spaced apart elements, said holder comprising:
a thin one piece metallic element having laterally opposing pairs of peripheral projections mechanically deformable to secure the element to the frame; and
a pair of spaced apart, laterally opposing, cantilevered portions, the space between said portions being dimensioned to receive and retain a pinched end of an arc tube.

31. The holder of claim 30 wherein said cantilevered portions are sufficiently resilient to permit limited axial movement of an arc tube when received therebetween, thereby reducing the susceptibility of the lamp to failure due to mechanical shock.

32. A method of mounting an arc tube within the outer lamp envelope of an HID lamp comprising the steps of:
a. providing an outer lamp envelope having an opening at one end;
b. providing a stem assembly comprising a stem and first and second stem leads each providing an electrical connection from the interior of the lamp envelope to the exterior of the lamp envelope;
c. supporting an elongated frame at one end from the stem assembly without a weld;
d. supporting a pair of spaced apart reflectors from the frame without a weld, one of the reflectors being supported adjacent the lamp stem, the other of the reflectors being supported adjacent the distal end of said frame;
e. supporting a pair of spaced apart arc tube holders from the frame between the pair of reflectors;
f. supporting one end of a double ended arc tube from one of the arc tube holders and supporting the other end of the arc tube from the other arc tube holder, the arc tube having an electrical lead extending from each end thereof;
g. electrically coupling one of the stem leads to one of the arc tube leads;
h. electrically coupling the other stem lead to the other arc tube lead; and
i. mounting a lamp base and the stem assembly at the open end of the outer lamp envelope so that the arc tube is supported within the outer lamp envelope.

33. The method of claim 32 further comprising the step of providing one or more electrically insulative passages through the reflector adjacent the stem assembly.

34. The method of claim 33 wherein the step of providing one or more electrically insulative passages through the reflector comprises the steps of forming an aperture in the reflector and mounting an insulator within the aperture, the insulator comprising electrically insulative material forming one or more wire guiding apertures.

35. The method of claim 34 wherein the steps of electrically coupling the stem leads with the arc tube leads comprises the step of passing one electrically conductive wire through a wire guiding aperture and passing another electrically conductive wire through another wire guiding aperture.

36. The method of claim 32 wherein the frame comprises substantially parallel elongated legs and the step of supporting a pair of arc tube holders from the frame comprises the steps of inserting a portion of one leg into one tab formed by the holder, inserting a portion of the other leg into another tab formed by the holder, and deforming the tabs to thereby frictionally engage the portions of the legs inserted therein.

37. The method of claim 32 wherein the frame comprises substantially parallel elongated legs and the step of supporting a pair of reflectors from the frame comprises the steps of inserting a portion of one leg into one a tab formed by the reflector, inserting a portion of the other leg into another tab formed by the reflector, and compressing the tabs to thereby frictionally engage the portions of the legs inserted therein.

38. A method of providing a shock absorbing mount for an arc tube in an HID lamp comprising the steps of:
a. providing an outer lamp envelope;
b. mounting an elongated frame within the envelope, the frame having spaced apart elements;
c. mounting a pair of spaced apart arc tube holders along the length of the frame, the arc tube holders comprising a thin one-piece element having a pair of spaced apart laterally opposing cantilevered portions;
d. inserting one pinched end of an arc tube into the space between the cantilevered portions of one of the arc tube holders;
e. inserting the other pinched end of the arc tube into the space between the cantilevered portions of the other arc tube holder to thereby support the arc tube between the arc tube holders, wherein the cantilevered portions are sufficiently resilient to permit limited axial movement of the arc tube supported therebetween to thereby reduce the susceptibility of the lamp to failure induced by mechanical shock.
